(19) United States
(12) Patent Application Publication
(10) Pub. No.: US 2011/0170007 A1
(43) Pub. Date: Jul. 14, 2011

(54) Image processing device, image control method, and computer program

(75) Inventor: Hidetoshi Yamaguchi, Saitama (JP)

(73) Assignee: Sony Corporation, Tokyo (JP)

(21) Appl. No.: 12/930,329

(22) Filed: Jan. 4, 2011

(30) Foreign Application Priority Data
Jan. 13, 2010 (JP) JP 2010-004563

(51) Int. Cl. H04N 9/74

(52) U.S. Cl. 348/586; 348/E09.055

(57) ABSTRACT

There is provided an image processing device that includes an information superimposition portion, a display format acquisition portion, and a superimposition control portion. The information superimposition portion superimposes specified information on an input image and outputs the image with the superimposed information. The display format acquisition portion acquires information about a display format of an image that is currently being displayed. The superimposition control portion, based on the information that the display format acquisition portion has acquired about the display format of the image that is currently being displayed, performs control that relates to the superimposing of the superimposed information on the input image by the information superimposition portion. This configuration makes it possible to correctly superimpose information on an image irrespective of the image format.

### BACKGROUND OF THE INVENTION

1. Field of the Invention

The present invention relates to an image processing device, an image control method, and a computer program.

2. Description of the Related Art

It is conceivable that a 3-D broadcast service might become widespread in the future that, by displaying three-dimensional (3-D) images on a screen, would allow a viewer to enjoy a stereoscopic image. Methods for displaying the 3-D images might include, for example, a side-by-side (SBS) method, an over-under method, a frame sequential (FSQ) method, and the like.

The side-by-side method is a method in which the image is transmitted with the frame divided into left and right portions. In an image display device that is compatible with the side-by-side method, a stereoscopic image can be constructed from the divided left and right images, but in an image display device that is not compatible, the image for the right eye is displayed on the right side of the frame, and the image for the left eye is displayed on the left side of the frame. The over-under method is a method in which the image is transmitted with the frame divided into upper and lower portions. In the same manner as with the side-by-side method, in an image display device that is compatible with the over-under method, a stereoscopic image can be constructed from the divided upper and lower images, but in an image display device that is not compatible, the same image is displayed symmetrically in the upper and lower portions of the frame.

The frame sequential method is a method in which the image is output by sequentially switching back and forth between an image stream for the right eye and an image stream for the left eye. An image that is displayed by this sort of frame sequential method can be perceived as a stereoscopic image by a viewer who uses, for example, a time-division stereoscopic image display system that utilizes what are called shutter glasses (refer, for example, to Japanese Patent Application Publication No. JP-A-9-138384, Japanese Patent Application Publication No. JP-A-2000-36969, and Japanese Patent Application Publication No. JP-A-2003-45343).

### SUMMARY OF THE INVENTION

Televisions and recorders have on-screen display (OSD) functions that superimpose text and graphics on an image, making them capable of displaying various types of information on an image. However, with methods that display an image by dividing the frame into a plurality of areas on the left and right, at the top and bottom, or the like, as the side-by-side method and the over-under method do, cases occur in which the text and graphics that are superimposed on the image by the OSD function are divided between the areas. In particular, when an image that uses one of the side-by-side method and the over-under method is output to the television from a recorder, a problem occurs in that the superimposed text and graphics are not displayed correctly on the television screen.

If information that identifies the method that is used for the image has been included the source image, then when the image that has been created by one of the side-by-side method and the over-under method is output from the recorder to the television, control can be performed such that the method that is used for the image can be recognized, the method by which the text and graphics are superimposed can be altered, information about the method that is used for the image can be acquired from the television, and the image for the television can be temporarily converted into a two-dimensional image. However, the information that identifies the method that is used for the image is not currently being included in the source image. In the standards for Version 1.4 of the High-Definition Multimedia Interface (HDMI), the side-by-side method is defined as the 3-D standard, but the actual state of affairs is that the standard is not being utilized very much, so for the purpose of broadcasting, the standard itself has not yet been fully implemented. Another issue is that the over-under method has not been defined in the current 3-D standards. Therefore, a problem has arisen in that there is currently no way to identify the method that is used for the image.

Accordingly, the present invention, in light of the problems that are described above, provides an image processing device, an image control method, and a computer program that are new and improved and that are capable of correctly superimposing information on an image irrespective of the image format.

In order to address the issues that are described above, according to an aspect of the present invention, there is provided an image processing device that includes an information superimposition portion, a display format acquisition portion, and a superimposition control portion. The information superimposition portion superimposes specified information on an input image and outputs the image with the superimposed information. The display format acquisition portion acquires information about a display format of an image that is currently being displayed. The superimposition control portion, based on the information that the display format acquisition portion has acquired about the display format of the image that is currently being displayed, performs control that relates to the superimposing of the superimposed information on the input image by the information superimposition portion.

The superimposition control portion may also issue a command to the information superimposition portion to superimpose the superimposed information in a manner that conforms to the display format of the image that is currently being displayed that has been acquired by the display format acquisition portion.

In a case where the display format of the image that is currently being displayed that has been acquired by the display format acquisition portion is a side-by-side format, the superimposition control portion may also issue a command to the information superimposition portion to superimpose the same superimposed information on the left side and the right side of the image.

In a case where the display format of the image that is currently being displayed that has been acquired by the display format acquisition portion is an over-under format, the superimposition control portion may also issue a command to the information superimposition portion to superimpose the same superimposed information on the upper side and the lower side of the image.

In a case where the display format of the image that is currently being displayed that has been acquired by the display format acquisition portion is a frame sequential format, the superimposition control portion may also issue a command to the information superimposition portion to superimpose the superimposed information on the image in the same manner as the superimposed information is superimposed on a two-dimensional image.

The superimposition control portion may also transmit a command to display as a two-dimensional image the image that is currently being displayed.

The superimposition control portion may also control the superimposing of the superimposed information on the input image by the information superimposition portion such that the superimposed information is displayed correctly when the image is displayed as a two-dimensional image.

When the superimposing of the superimposed information by the information superimposition portion has been completed, the superimposition control portion may also transmit a command to display the image in the display format that was being used before the display was changed to the two-dimensional image.

In order to address the issues that are described above, according to another aspect of the present invention, there is provided an image control method that includes a step of superimposing specified information on an input image and outputting the image with the superimposed information. The image control method also includes a step of acquiring information about a display format of an image that is currently being displayed. The image control method also includes a step of performing control, based on the information that has been acquired about the display format of the image that is currently being displayed, that relates to the superimposing of the superimposed information on the input image.

In order to address the issues that are described above, according to another aspect of the present invention, there is provided a computer program that causes a computer to perform a step of superimposing specified information on an input image and outputting the image with the superimposed information. The computer program also causes the computer to perform a step of acquiring information about a display format of an image that is currently being displayed. The computer program also causes the computer to perform a step of performing control, based on the information that has been acquired about the display format of the image that is currently being displayed, that relates to the superimposing of the superimposed information on the input image.

According to the present invention that has been explained above, there can be provided an image processing device, an image control method, and a computer program that are new and improved and that are capable of correctly superimposing information on an image irrespective of the image format.

### BRIEF DESCRIPTION OF THE DRAWINGS

FIG. 1 is an explanatory figure that shows an image display system 10 according to an embodiment of the present invention;

FIG. 2 is an explanatory figure that shows an overview of a case in which a 3-D image is displayed based on a source image that has been recorded by a side-by-side method;

FIG. 3 is an explanatory figure that shows an example of a case in which information that was superimposed by a recorder is displayed in divided form on a television screen;

FIG. 4 is an explanatory figure that shows a functional configuration of a recorder 100 according to the embodiment of the present invention;

FIG. 5 is a flowchart that shows an operation of the recorder 100 according to the embodiment of the present invention;

FIG. 6 is an explanatory figure that shows an example of a method by which an image format identification portion 160 according to the embodiment of the present invention identifies an image format of a stream;

FIG. 7 is an explanatory figure that shows a functional configuration of the recorder 100 and a television 200 according to the embodiment of the present invention;

FIG. 8 is a flowchart that shows operations of the recorder 100 and the television 200 according to the embodiment of the present invention;

FIG. 9A is an explanatory figure that shows an example of information that is superimposed on an image;

FIG. 9B is an explanatory figure that shows an example of information that is superimposed on an image;

FIG. 9C is an explanatory figure that shows an example of information that is superimposed on an image;

FIG. 10 is a flowchart that shows the operations of the recorder 100 and the television 200 according to the embodiment of the present invention;

### DETAILED DESCRIPTION OF EMBODIMENT

Hereinafter, a preferred embodiment of the present invention will be described in detail with reference to the appended drawings. Note that, in this specification and the appended drawings, structural elements that have substantially the same function and structure are denoted with the same reference numerals, and repeated explanation of these structural elements is omitted.

Note that the explanation will be in the order shown below.

1. Embodiment of the present invention
1-1. Example configuration of image display system
1-2. Example configuration of recorder
1-3. Operation of Recorder
1-4. Functional configuration of recorder and television
1-5. Operation of recorder and television

2. Conclusion

### 1. Embodiment of the Present Invention

### 1-1. Example Configuration of Image Display System

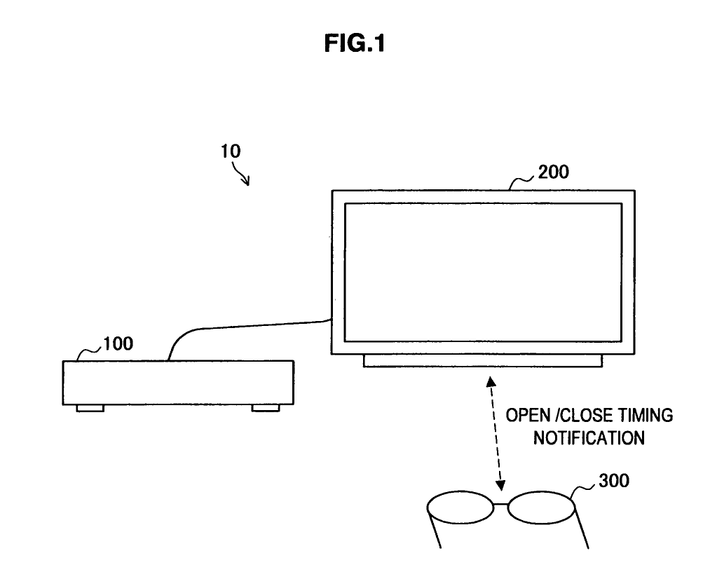

First, an example configuration of an image display system according to an embodiment of the present invention will be explained with reference to FIG. 1. FIG. 1 is an explanatory figure that shows an image display system 10 according to the embodiment of the present invention. As shown in FIG. 1, the image display system 10 according to the embodiment of the present invention is configured such that it includes a recorder 100, a television 200, and shutter glasses 300.

The recorder 100 is an example of an image output device of the present invention, and a source image that is displayed on the television 200 is stored in the recorder 100. The recorder 100 stores the source image in a storage medium such as a hard disk, an optical disk, a flash memory, or the like, and it has a function that outputs the source image that is stored in the storage medium. The recorder 100 also has an OSD function that superimposes text and graphics on an image, and it also has a function that identifies the image format of the source image when the stored source image is output.

The television 200 is an example of an image display device of the present invention, and it displays an image that is transmitted from a broadcasting station and an image that is output from the recorder 100. The television 200 according to the present embodiment is an image display device that can display a 3-D image that can be recognized as a stereoscopic image by a viewer who views the image through the shutter glasses 300. In the present embodiment, the recorder 100 and the television 200 are connected by an HDMI cable. Of course, in the present invention, the form in which the recorder 100 and the television 200 are connected is not limited to this example.

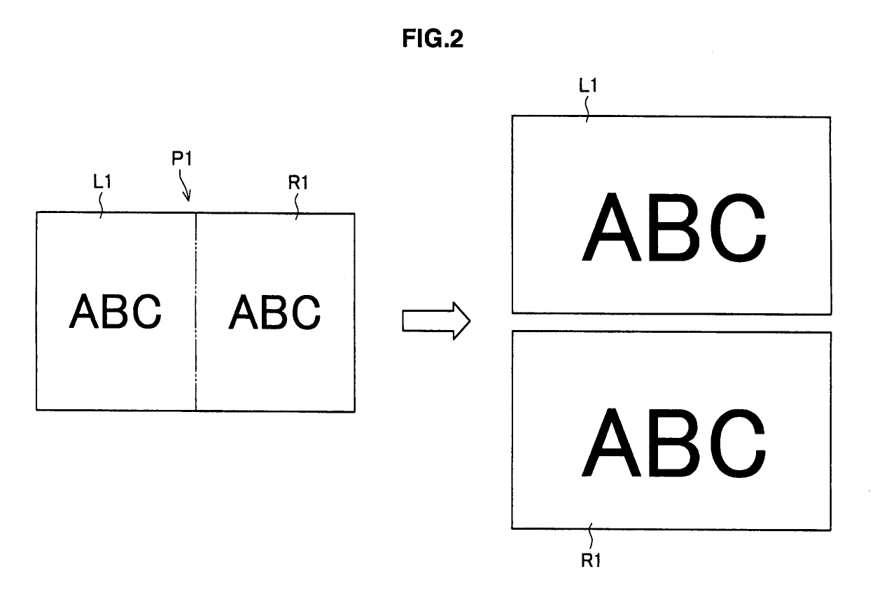

The relationship between the image that the recorder 100 outputs and the image that the television 200 displays will be explained using as an example a source image that has been recorded by a side-by-side method. FIG. 2 is an explanatory figure that shows an overview of a case in which a 3-D image is displayed based on the source image that has been recorded by the side-by-side method. With the side-by-side method, the image is transmitted to the television in a state in which the frame is divided into left and right portions. In the television 200, an image for the left eye and an image for the right eye are created from a single image, and the image for the left eye and the image for the right eye are displayed at different times.

The example in FIG. 2 shows a case in which a single frame P1 is divided into a right eye image R1 on the right side and a left eye image L1 on the left side, and a stereoscopic image is displayed by displaying the right eye image R1 and the left eye image L1 in alternation.

Therefore, if information is superimposed on the image by the OSD function in the recorder, the superimposed information may be displayed by the television such that it is divided between the right eye image R1 and the left eye image L1, depending on the position in which the information is superimposed. Specifically, if the information is superimposed by the recorder such that it straddles the boundary line between the left and right sides, the superimposed information will be displayed by the television such that it is divided between the right eye image R1 and the left eye image L1.

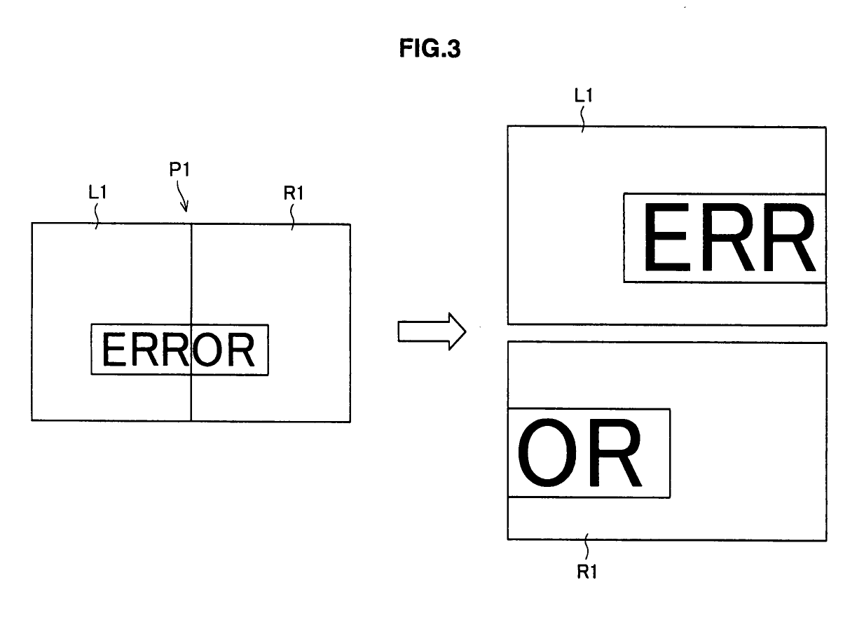

FIG. 3 is an explanatory figure that shows an example of a case in which information that was superimposed by the recorder is displayed in divided form by the television. FIG. 3 shows a case in which the recorder has superimposed the word “ERROR” on the single frame P1 and output the image to the television. When the text is superimposed such that it straddles the boundary line that divides the right eye image R1 and the left eye image L1, as shown in FIG. 3, the superimposed text is divided when the 3-D image is constructed by the television, so the text that was superimposed by the recorder is not displayed correctly when the 3-D image is displayed by the television.

Accordingly, the recorder 100 according to the present embodiment has a function that uses image processing to identify the format of the image that is output. This identification function makes it possible for the recorder 100 to change the method by which the information is superimposed by the OSD function and to issue a command to the television 200 to temporarily stop displaying the 3-D image.

The image display system 10 according to the embodiment of the present invention has been explained above. Next, a functional configuration of the recorder 100 according to the embodiment of the present invention will be explained.

### 1-2. Example Configuration of Recorder

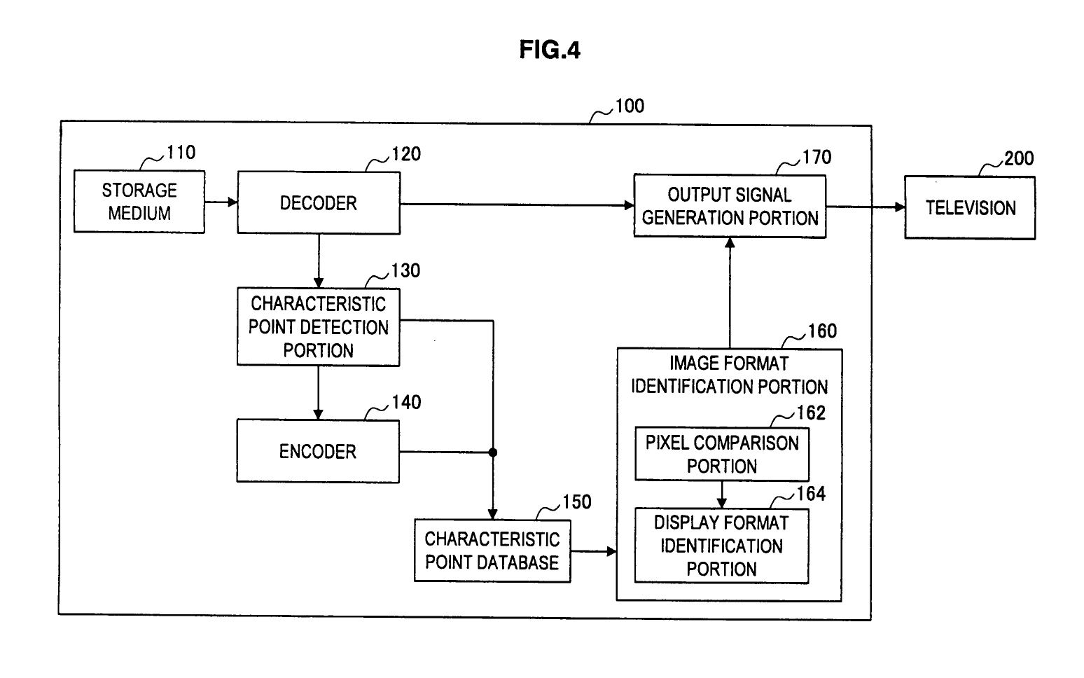

FIG. 4 is an explanatory figure that shows the functional configuration of the recorder 100 according to the embodiment of the present invention. Hereinafter, the functional configuration of the recorder 100 according to the embodiment of the present invention will be explained using FIG. 4.

As shown in FIG. 4, the recorder 100 according to the embodiment of the present invention is configured such that it includes a storage medium 110, a decoder 120, a characteristic point detection portion 130, an encoder 140, a characteristic point database 150, an image format identification portion 160, and an output signal generation portion 170.

The storage medium 110 is the storage medium in which the source image is stored, and various types of storage media can be used as the storage medium 110, such as a hard disk, an optical disk, a flash memory, or the like, for example. An image for which a single frame is divided into a plurality of areas, as in the side-by-side method, the over-under method, and the like, is stored in the storage medium 110, and the image can be output in that form to the television 200.

The decoder 120 decodes the source image that is stored in the storage medium 110. Once the decoder 120 has decoded the source image, it outputs a post-decoding image and audio signal to the output signal generation portion 170 and outputs a post-decoding image stream to the characteristic point detection portion 130 in order for the image format to be identified.

The characteristic point detection portion 130 performs processing that detects characteristic points in the image stream that has been decoded by the decoder 120, the characteristic points being used at a later stage by the image format identification portion 160 to identify the image format. Information on the characteristic points that have been detected by the characteristic point detection portion 130 (characteristic point information) is stored in the characteristic point database 150. After the characteristic point detection, the image stream is sent from the characteristic point detection portion 130 to the encoder 140.

The encoder 140 encodes the image stream and generates a stream for image recording. The stream for image recording that the encoder 140 has encoded is sent to the characteristic point database 150.

The characteristic point database 150 takes the information on the characteristic points that the characteristic point detection portion 130 has detected and stores it as a time series. The characteristic point information that is stored as a time series in the characteristic point database 150 is used at a later stage by the image format identification portion 160 in the processing that identifies the image format.

The image format identification portion 160 uses the characteristic point information that is stored as a time series in the characteristic point database 150 to identify the image format of the image that is being output from the recorder 100. Information on the image format that the image format identification portion 160 has identified is sent to the output signal generation portion 170. The processing by which the image format identification portion 160 identifies the image format will be described in detail later.

As shown in FIG. 4, the image format identification portion 160 is configured such that it includes a pixel comparison portion 162 and a display format identification portion 164. The pixel comparison portion 162 compares the pixels of the characteristic points that have been stored as the time series in the characteristic point database 150 and determines whether or not the characteristic points match. The results of the comparisons in the pixel comparison portion 162 are sent to the display format identification portion 164. The display format identification portion 164, using the results of the comparisons in the pixel comparison portion 162, identifies the image format of the image that has been decoded by the decoder 120 and output from the recorder 100.

The output signal generation portion 170 uses the post-decoding image and audio signal from the decoder 120 to generate an output signal to be supplied to the television 200. In the present embodiment, the output signal generation portion 170 generates an output signal that conforms to the High-Definition Multimedia Interface (HDMI) standard. The output signal generation portion 170 also generates the output signal such that it incorporates the information on the image format that has been identified by the image format identification portion 160.

The output signal generation portion 170 may also have an OSD function that superimposes information on the image that has been decoded by the decoder 120. The information that is superimposed on the image may include, for example, the title of the image that is currently being displayed, the display time of the image, information on displaying, pausing, and stopping the image, and the like.

The functional configuration of the recorder 100 according to the embodiment of the present invention has been explained above. Note that the recorder 100 that is shown in FIG. 4 is configured such that the image that is stored in the storage medium 110 is decoded by the decoder 120, but the present invention is not limited to this example. The recorder 100 may also be configured such that it receives broadcast waves from a broadcasting station and uses the decoder 120 to decode the received broadcast waves. Next, an operation of the recorder 100 according to the present embodiment of the present invention will be explained.

### 1-3. Operation of Recorder

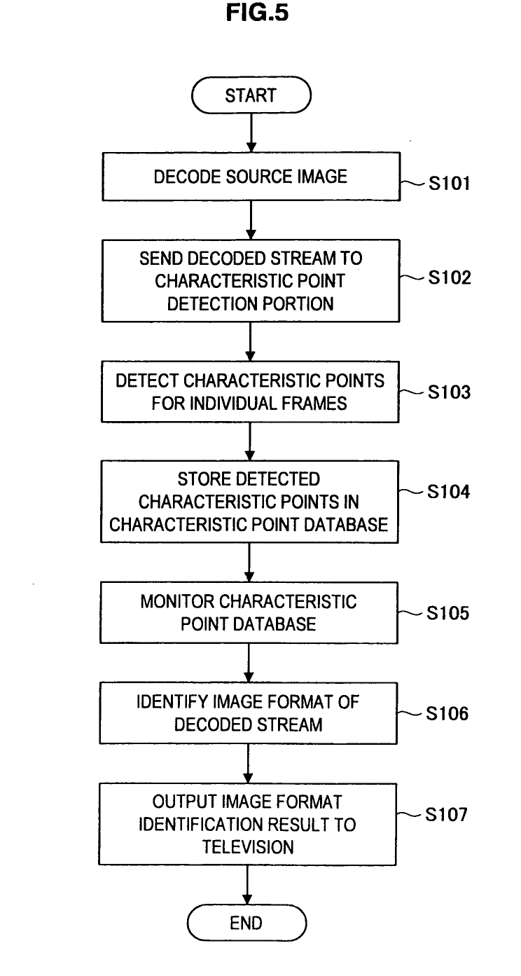

FIG. 5 is a flowchart that shows the operation of the recorder 100 according to the embodiment of the present invention. FIG. 5 shows the operation when the image format identification portion 160 identifies the format of the displayed image when the source image that has been stored in the storage medium 110 is displayed. Hereinafter, the operation of the recorder 100 according to the present embodiment of the present invention will be explained using FIG. 5.

When the source image that has been stored in the storage medium 110 is displayed, first the source image that is to be displayed is read from the storage medium 110, and the decoder 120 decodes the source image that has been read from the storage medium 110 (Step S101). The stream that has been decoded by the decoder 120 is then sent to the characteristic point detection portion 130 (Step S102).

The characteristic point detection portion 130 performs processing that detects the characteristic points in the decoded stream (Step S103). The characteristic point detection portion 130 performs the processing that detects the characteristic points with respect to individual frames in the decoded stream. Note that, in consideration of the processing capacity, the characteristic point detection portion 130 may also perform the processing such that it detects the characteristic points in the decoded stream once every several frames or once every several seconds.

The characteristic point detection portion 130 may, for example, detect the amounts of change between adjacent pixels within an individual frame, detect specific colors (flesh tones, for example), detect displayed subtitles, and the like, then identify the characteristic points within the individual frame by treating the amounts of change and distribution ratios as parameters.

The characteristic point detection portion.130 takes information on the characteristic points it has detected and stores it stores as a time series in the characteristic point database 150 (Step S104). The image format identification portion 160 sequentially monitors the characteristic point information that has been stored in the characteristic point database 150 (Step S105) and identifies the image format of the stream that has been decoded by the decoder 120 (Step S106). When the image format identification portion 160 identifies the image format of the stream, the image format identification portion 160 outputs the identification result to the output signal generation portion 170.

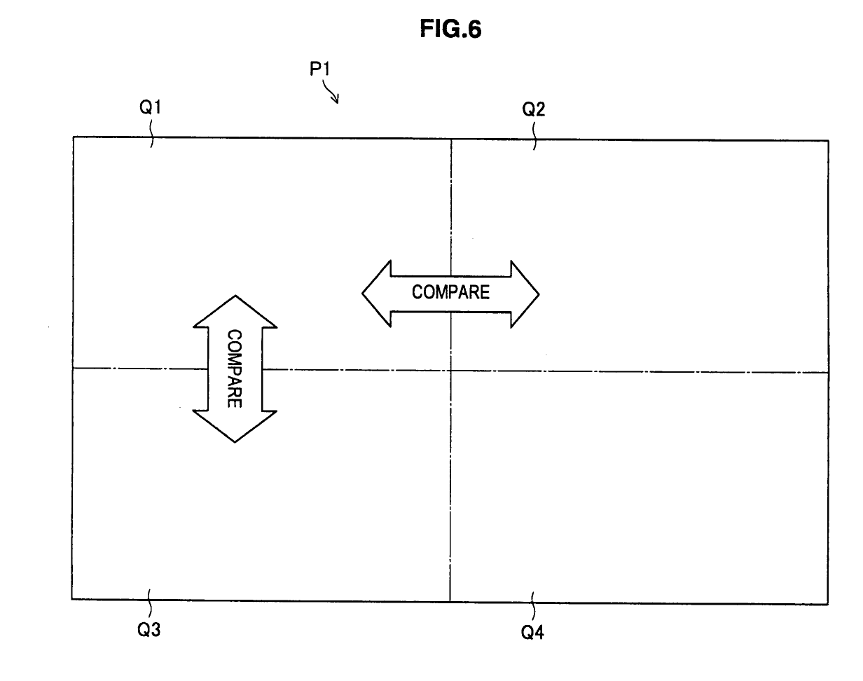

FIG. 6 is an explanatory figure that shows an example of a method by which an image format identification portion 160 according to the embodiment of the present invention identifies the image format of the stream. In the present embodiment, the image format identification portion 160 identifies the image format of the stream by dividing the frame into four areas. FIG. 6 shows a case in which the single frame P1 is divided into two equal parts in both the vertical direction and the horizontal direction, such that it is divided into four areas Q1, Q2, Q3, and Q4.

After the frame has been divided in this manner into the four areas Q1, Q2, Q3, and Q4, the image format identification portion 160, by comparing the pixels that are in corresponding positions in the area Q1 and the area Q2, as well as in the area Q1 and the area Q3, identifies the image format of the stream that has been decoded by the decoder 120.

In other words, in a case where the pixels that are in corresponding positions in the area Q1 and the area Q2 are the same, the image format identification portion 160 is able to identify the image format of the stream that has been decoded by the decoder 120 as being the side-by-side format. On the other hand, in a case where the pixels that are in corresponding positions in the area Q1 and the area Q3 are the same, the image format identification portion 160 is able to identify the image format of the stream that has been decoded by the decoder 120 as being the over-under format.

In comparing the pixels between the areas, the image format identification portion 160 can achieve the greatest reliability for the identification result by comparing all of the pixels within each of the areas. However, actually comparing all of the pixels within each of the areas requires an enormous amount of processing and may significantly lengthen the time required for the identification processing. Accordingly, the characteristic points within the image are detected in advance by the characteristic point detection portion 130, as described above, so the length of time that is required for the identification processing can be shortened by having the image format identification portion 160 detect the areas in which the characteristic points are located. Note that in identifying the image format, the image format identification portion 160 is not limited to using the locations of the characteristic points and may also make use of transitions in the characteristic points within the individual areas over time. If the transitions in the characteristic points over time are the same for the area Q1 and the area Q2, then the image format identification portion 160 may identify the image format as the side-by-side format, and if the transitions in the characteristic points over time are the same for the area Q1 and the area Q3, then the image format identification portion 160 may identify the image format as the over-under format.

Note that in the present embodiment, the image format identification portion 160 identifies the image format using the information on the characteristic points that is stored in the characteristic point database 150, but the present invention is not limited to this example. For example, the stream that has been decoded by the decoder 120 may also be supplied directly to the image format identification portion 160, and the image format identification portion 160 may perform the processing that identifies the image format using the stream that is supplied directly from the decoder 120.

The output signal generation portion 170, when outputting the stream that has been decoded by the decoder 120, appends to the stream the result of the image format identification by the image format identification portion 160 and transmits the stream to the television 200 (Step S107). The stream can be transmitted from the recorder 100 to the television 200 using HDMI, for example, but the result of the image format identification by the image format identification portion 160 can be transmitted from the recorder 100 to the television 200 as an HDMI output attribute, for example.

The television 200 that receives the result of the image format identification together with the stream from the recorder 100 is capable of ascertaining the image format of the stream that is transmitted from the recorder 100. Heretofore, it was not possible for the device that displays the image to determine how the image was to be displayed, because the information that identifies the format of the source image was not included. However, the identifying of the image format in which the source image is stored in the recorder 100 makes it possible for the television 200 to determine how the image is to be displayed by using the stream that is transmitted from the recorder 100. Furthermore, the identifying of the image format of the stream that the recorder 100 will transmit to the television 200 makes it possible to change the form in which information is superimposed on the image by the OSD function to a suitable form.

In the present embodiment, the image format identification portion 160 divides the single frame P1 into the four areas Q1, Q2, Q3, and Q4, as shown in FIG. 6, and by comparing the pixels that are in corresponding positions in the area Q1 and the area Q2, as well as in the area Q1 and the area Q3, and tracking the changes in the characteristic points, the image format identification portion 160 identifies the image format of the stream that has been decoded by the decoder 120.

In this manner, the image format identification portion 160 performs the processing that identifies the image format of the stream that is output from the recorder 100. The processing by the image format identification portion 160 that identifies the image format divides the image into the four equal areas at the top and bottom and the left and right and compares the pixels between the individual areas. Specifically, the single frame P1 into the four areas Q1, Q2, Q3, and Q4, as shown in FIG. 6, and the pixels that are in corresponding positions in the area Q1 and the area Q2, as well as in the area Q1 and the area Q3, are compared.

The result of the identification processing by the image format identification portion 160 is transmitted from the recorder 100 to the television 200. This makes it possible for the recorder 100 to control the superimposition of information on the image that will be displayed by the television 200, and also makes it possible for the television 200, by referencing the identification processing result that has been transmitted from the recorder 100, to ascertain the image format of the image that is currently being displayed. It then becomes possible for the image format of the image that is currently being displayed to be transmitted from the television 200 to the recorder 100.

### 1-4. Functional Configuration of Recorder and Television

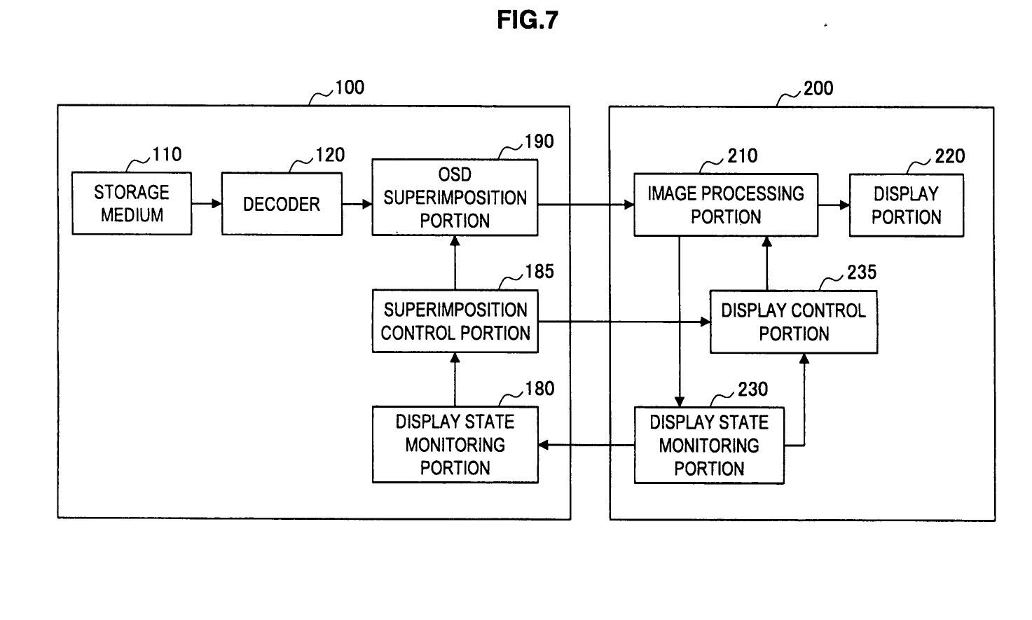

Next, a configuration that allows the recorder 100 to control the superimposition of the information by the OSD function and to issue a command to the television 200 to change the image display will be explained. FIG. 7 is an explanatory figure that shows a functional configuration of the recorder 100 and the television 200 according to the embodiment of the present invention. Hereinafter, the functional configuration of the recorder 100 and the television 200 according to the embodiment of the present invention will be explained using FIG. 7.

As shown in FIG. 7, the recorder 100 according to the embodiment of the present invention is configured such that it includes the storage medium 110, the decoder 120, a display state monitoring portion 180, a superimposition control portion 185, and an OSD superimposition portion 190. The television 200 according to the embodiment of the present invention is configured such that it includes an image processing portion 210, a display portion 220, a display state monitoring portion 230, and a display control portion 235.

The storage medium 110 is the storage medium in which the source image is stored, as described previously, and various types of storage media can be used as the storage medium 110, such as a hard disk, an optical disk, a flash memory, or the like, for example. An image for which a single frame is divided into a plurality of areas, as in the side-by-side method, the over-under method, and the like, is stored in the storage medium 110, and the image can be output in that form to the television 200.

The decoder 120 decodes the source image that is stored in the storage medium 110, as described previously. Once the decoder 120 has decoded the source image, it outputs a post-decoding image and audio signal to the OSD superimposition portion 190.

The display state monitoring portion 180 is an example of a display format acquisition portion of the present invention, and it monitors the state of the image that the television 200 is displaying on the display portion 220 and acquires the image format from the television 200. Specifically, the display state monitoring portion 180 receives, from the display state monitoring portion 230 of the television 200, information about the format of the image that is being displayed on the display portion 220, and the display state monitoring portion 180 sends the image format information that it has received to the superimposition control portion 185.

Based on the information that has been sent from the display state monitoring portion 180 about the format of the image that is being displayed on the display portion 220 of the television 200, the superimposition control portion 185 controls the method of superimposing the information that is superimposed by the OSD superimposition portion 190. In a case where the image that is being displayed on the display portion 220 of the television 200 is an ordinary two-dimensional (2-D) image, as well as in a case where a three-dimensional image is being displayed by the frame sequential method, the superimposed information will be displayed correctly on the display portion 220 even if the position where the information is superimposed is not changed. However, if the information is superimposed by the recorder 100 on an image in one of the side-by-side format and the over-under format, the superimposed information will be divided, as described previously, and the superimposed information cannot be displayed correctly on the display portion 220. Therefore, the superimposition control portion 185 has a function that controls the OSD superimposition portion 190 such that the information will be superimposed in an appropriate position according to the format of the image that is being displayed on the display portion 220. The superimposition control portion 185 also has a function that, by transmitting control information about the image signal to the television 200, controls the operation of the television 200 such that it causes the displayed image to temporarily revert to being a two-dimensional image in order to display the superimposed information correctly on the display portion 220.

The OSD superimposition portion 190 uses the OSD function to superimpose, as necessary, information such as text, graphics, and the like on the image that has been decoded by the decoder 120. Under the control of the superimposition control portion 185, the OSD superimposition portion 190 performs processing that superimposes the information in accordance with the format of the image that is being displayed on the display portion 220. The information that is superimposed by the OSD superimposition portion 190 may include, for example, the title of the image that is output, the display time of the image that is output, the display state of the image, such as displayed, paused, stopped, or the like, subtitles that are displayed in association with the image, and the like.

In superimposing the information on a three-dimensional image, the OSD superimposition portion 190 may also perform superimposition processing that takes into consideration the Z axis dimension of the image, that is, the directions toward the front and the rear of the display portion 220, and in particular, may superimpose the information such that it is displayed in the frontmost position. Note that in a case where the information that the OSD superimposition portion 190 superimposes jumps out extremely far to the front in the Z axis direction, the OSD superimposition portion 190 may also cancel the processing that superimposes the information.

Based on the stream that is transmitted from the recorder 100, the image processing portion 210 generates an image signal for displaying the image on the display portion 220, then outputs the signal to the display portion 220. If the stream that is transmitted from the recorder 100 is for displaying a two-dimensional image, or is for displaying a three-dimensional image using the frame sequential method, the image processing portion 210 generates the image signal based on the stream and outputs it at the appropriate timing. On the other hand, in a case where the stream that is transmitted from the recorder 100 is generated by one of the side-by-side method and the over-under method, and a three-dimensional image will be generated based on the stream and displayed on the display portion 220, the image processing portion 210 generates a right eye image and a left eye image for each frame in the stream that is transmitted from the recorder 100, then generates image signals such that the right eye image and the left eye image will be displayed in alternation on the display portion 220.

The recorder 100 can use the image format identification processing that was described earlier to identify the image format of the stream that is transmitted from the recorder 100, and transmitting the information about the image format from the recorder 100 to the television 200 makes it possible for the image format to be recognized by the television 200. Therefore, in a case where the television 200 is capable of displaying three-dimensional images in a plurality of image formats, the television 200 can use the information about the image format that was transmitted from the recorder 100 to display the three-dimensional image in accordance with the image format. The television 200 can also transmit to the recorder 100 the information about the image format of the image that is currently being displayed.

The display portion 220 displays the image based on the image signal that has been transmitted from the image processing portion 210. In a case where, in displaying the three-dimensional image, the display portion 220 displays the right eye image and the left eye image in alternation and the image that is displayed on the display portion 220 is viewed through the shutter glasses 300, the image can be viewed as a stereoscopic image, because liquid crystal shutters that are provided for the right eye and the left eye in the shutter glasses 300 are opened and closed in alternation, with the opening and closing timing matched to the image display on the display portion 220.

The display state monitoring portion 230 monitors the display state of the image that is being displayed on the display portion 220. Specifically, the display state monitoring portion 230 monitors the image that is being displayed on the display portion 220 by monitoring the image format for which the image processing portion 210 is processing the image signal.

The display control portion 235 controls the method by which the image processing portion 210 processes the image signal, and changes accordingly the method by which the image that is being displayed the display portion 220 is displayed. More specifically, the display control portion 235 acquires the control information about the image signal that is transmitted from the superimposition control portion 185, then based on the control information, issues a command to the image processing portion 210 to change the method for processing the image signal. Having received the change command from the display control portion 235, the image processing portion 210, based on the command, changes the method for processing the stream that has been transmitted from the recorder 100.

The functional configuration of the recorder 100 and the television 200 according to the embodiment of the present invention has been explained above. Next, the operation of the recorder 100 and the television 200 according to the embodiment of the present invention will be explained using FIG. 7.

1-5. Operation of Recorder and Television

Various types of methods can be imagined for correctly displaying on the television 200 the information that is superimposed by the recorder 100, but two methods will be explained here: (1) a method for controlling the method for superimposing the information in the recorder 100, and (2) a method for controlling the display on the television 200 from the recorder 100.

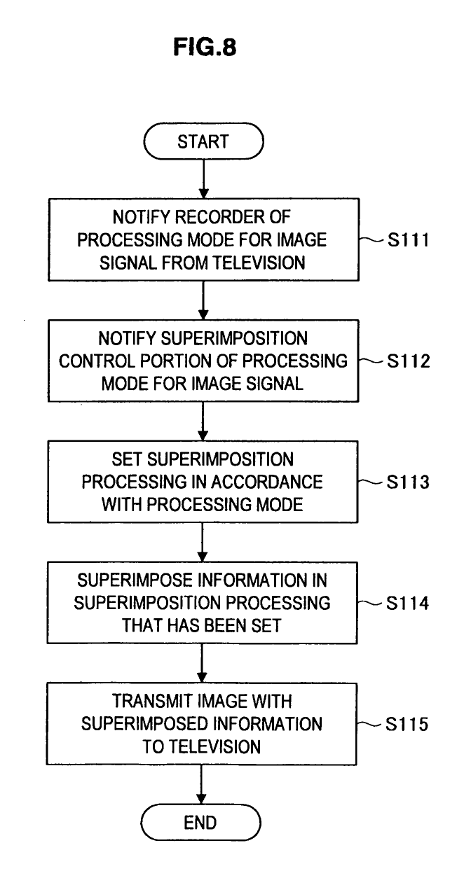

First, (1) the method for controlling the method for superimposing the information in the recorder 100 will be explained. FIG. 8 is a flowchart that shows operations of the recorder 100 and the television 200 according to the embodiment of the present invention (1) in a case where the method for superimposing the information in the recorder 100 is being controlled. Hereinafter, the operations of the recorder 100 and the television 200 according to the embodiment of the present invention will be explained using FIG. 8.

First, in the television 200, the processing mode for the image signal is monitored by the display state monitoring portion 230. The processing mode for the image signal determines the image format for which the image signal is processed by the image processing portion 210. In the present embodiment, the modes that are listed below are defined as the processing modes for the image signal.

(1) 3-D (frame sequential) mode

(2) Side-by-side mode

(3) Over-under mode

(4) 2-D mode

(5) Pseudo 3-D mode

(1) The 3-D (frame sequential) mode is a mode in which the image processing portion 210 processes the image signal using the frame sequential method. The image processing portion 210 performs signal processing on the stream that has been transmitted from the recorder 100 in the frame sequential format, then transmits the image signal to the display portion 220 at the appropriate timing, making it possible for the right eye image and the left eye image to be displayed in alternation on the display portion 220.

(2) The side-by-side mode is a mode in which the image processing portion 210 processes the image signal using the side-by-side method. The image processing portion 210 performs signal processing on the stream that has been transmitted from the recorder 100 in the side-by-side format, constructs the right eye image and the left eye image, then transmits the image signal to the display portion 220 at the appropriate timing, making it possible for the right eye image and the left eye image to be displayed in alternation on the display portion 220.

(3) The over-under mode is a mode in which the image processing portion 210 processes the image signal using the over-under method. The image processing portion 210 performs signal processing on the stream that has been transmitted from the recorder 100 in the over-under format, constructs the right eye image and the left eye image, then transmits the image signal to the display portion 220 at the appropriate timing, making it possible for the right eye image and the left eye image to be displayed in alternation on the display portion 220.

(4) The 2-D mode is a mode in which the image processing portion 210 processes the image signal such that the image that is displayed on the display portion 220 is a two-dimensional image. The 2-D mode includes signal processing that takes a stream that has been transmitted from the recorder 100 as a two-dimensional image and displays the two-dimensional image in that form on the display portion 220. The 2-D mode also includes signal processing that takes a stream that has been transmitted from the recorder 100 as a three-dimensional image and forcibly displays it as a two-dimensional image on the display portion 220. The signal processing that forcibly displays the three-dimensional image as a two-dimensional image on the display portion 220 has been devised for a case in which, even though the stream has been transmitted from the recorder 100 to the television 200 in order to be displayed as a three-dimensional image, the user of the television 200 wants to view it on the television 200 as a two-dimensional image, rather than as a three-dimensional image.

(5) The pseudo 3-D mode is a mode in which the image processing portion 210 processes the image signal such that a pseudo three-dimensional image is created from a two-dimensional image and is displayed on the display portion 220. In the pseudo 3-D mode, the image processing portion 210 can create the pseudo three-dimensional image and display it on the display portion 220 even if the source image is a two-dimensional image. Note that various types of methods have been proposed as the method for creating the pseudo three-dimensional image from the two-dimensional image, but the method is not directly related to the present invention, so a detailed explanation will be omitted.

The image processing portion 210 performs the signal processing by operating in one of the five processing modes that have been described above. Further, the display state monitoring portion 230 monitors the processing mode in which the image processing portion 210 is operating to perform the signal processing. The display state monitoring portion 230 transmits information on the processing mode of the image processing portion 210 to the recorder 100 (Step S111). For example, in the case of (1) the 3-D (frame sequential) mode, the display state monitoring portion 230 may transmit the information on the processing mode of the image processing portion 210 to the recorder 100 at the time when the information on the image format is transmitted from the recorder 100. In the case of one of (2) the side-by-side mode and (3) the over-under mode, the display state monitoring portion 230 may transmit the information on the processing mode of the image processing portion 210 to the recorder 100 at the time when the information on the image format is transmitted from the recorder 100 and at the time when the user of the television 200 issues a command to the television 200 to display the three-dimensional image on the display portion 220.

The information on the processing mode of the image processing portion 210 that is transmitted from the display state monitoring portion 230 may be acquired by the display state monitoring portion 180 through the High-Definition Multimedia Interface-Consumer Electronics Control (HDMI-CEC), for example. The display state monitoring portion 180, having acquired the information on the processing mode of the image processing portion 210, provides the information it has acquired on the processing mode of the image processing portion 210 to the superimposition control portion 185 (Step S112).

The superimposition control portion 185, having received the information on the processing mode of the image processing portion 210 from the display state monitoring portion 180 at Step S112, sets the superimposition processing in the OSD superimposition portion 190 in accordance with the processing mode of the image processing portion 210 (Step S113).

An example of the setting of the superimposition processing by the superimposition control portion 185 will be explained. In a case where it has been determined from the processing mode that has been transmitted from the television 200 that a two-dimensional image is currently being displayed on the television 200, the superimposition control portion 185 controls the OSD superimposition portion 190 such that the information is superimposed on the image by ordinary superimposition processing. In other words, in a case where a two-dimensional image is being displayed on the television 200, the superimposition control portion 185 controls the OSD superimposition portion 190 such that the information is superimposed without altering the font or the coordinates. In a case where it has been determined that a three-dimensional image is being displayed on the television 200 using the frame sequential method, the superimposition control portion 185 also controls the OSD superimposition portion 190 such that the information is superimposed on the image by ordinary superimposition processing.

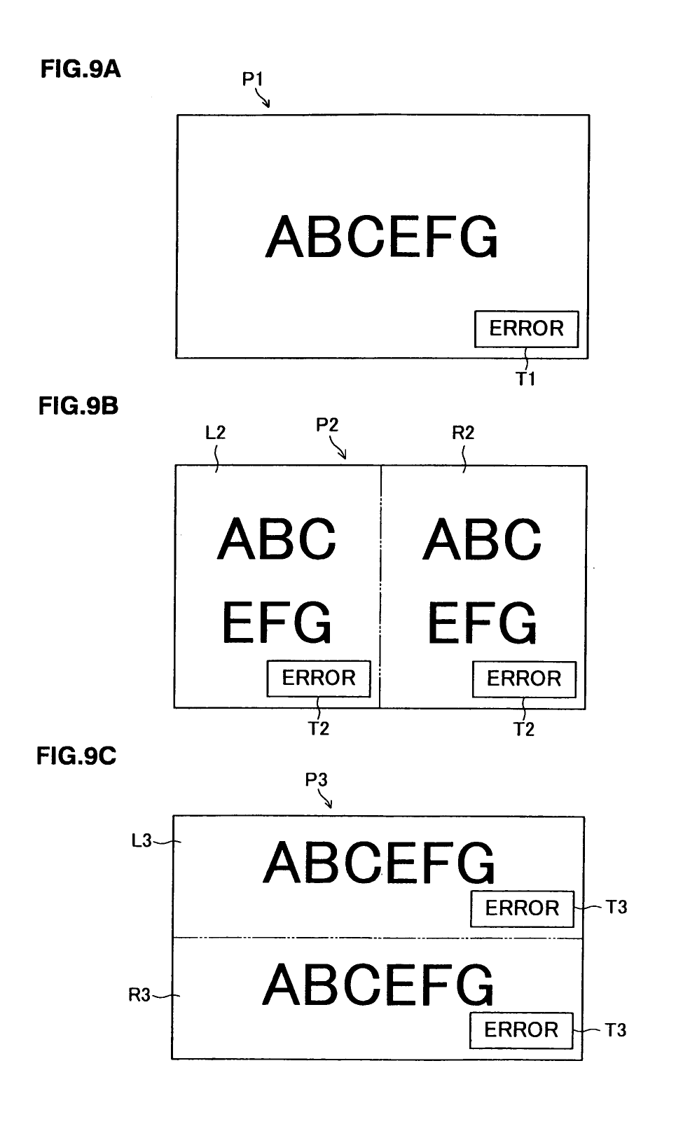

FIG. 9A is an explanatory figure that shows an example of the information that is superimposed on the image by the OSD superimposition portion 190 in a case where a two-dimensional image is being displayed on the television 200, as well as in a case where a three-dimensional image is being displayed by the frame sequential method. As shown in FIG. 9A, in the case where the two-dimensional image is being displayed on the television 200, as well as in the case where the three-dimensional image is being displayed by the frame sequential method, the superimposition control portion 185 controls the OSD superimposition portion 190 such that information T1 that includes the text “ERROR” is superimposed on an image P1.

However, in a case where it has been determined, based on the processing mode that has been transmitted from the television 200, that a three-dimensional image is currently being displayed on the television 200 using the side-by-side method, the superimposition control portion 185 controls the OSD superimposition portion 190 such that the information is superimposed on the image by superimposition processing that is appropriate for the side-by-side method. In other words, in the case where a three-dimensional image is being displayed on the television 200 using the side-by-side method, the superimposition control portion 185 controls the OSD superimposition portion 190 such that the font and the coordinates are changed and the same information is superimposed on both the left eye image and the right eye image.

FIG. 9B is an explanatory figure that shows an example of the information that is superimposed on the image by the OSD superimposition portion 190 in a case where a three-dimensional image is being displayed on the television 200 using the side-by-side method. As shown in FIG. 9B, in the case where the three-dimensional image is being displayed on the television 200 using the side-by-side method, the superimposition control portion 185 controls the OSD superimposition portion 190 such that information T2 that includes the text “ERROR” is superimposed on an image P2 that includes a right eye image R2 and a left eye image L2 in a divided state.

In the same manner, in a case where it has been determined that a three-dimensional image is currently being displayed on the television 200 using the over-under method, the superimposition control portion 185 controls the OSD superimposition portion 190 such that the information is superimposed on the image by superimposition processing that is appropriate for the over-under method. In other words, in the case where a three-dimensional image is being displayed on the television 200 using the over-under method, the superimposition control portion 185 controls the OSD superimposition portion 190 such that the font and the coordinates are changed and the same information is superimposed on both the upper image and the lower image.

FIG. 9C is an explanatory figure that shows an example of the information that is superimposed on the image by the OSD superimposition portion 190 in a case where a three-dimensional image is being displayed on the television 200 using the over-under method. As shown in FIG. 9C, in the case where the three-dimensional image is being displayed on the television 200 using the over-under method, the superimposition control portion 185 controls the OSD superimposition portion 190 such that information T3 that includes the text “ERROR” is superimposed on an image P3 that includes a right eye image R3 and a left eye image L3 in a divided state.

In this manner, the superimposition control portion 185, having received the information on the processing mode of the image processing portion 210 from the display state monitoring portion 180, is able to set the superimposition processing in the OSD superimposition portion 190 in accordance with the processing mode of the image processing portion 210. Setting the superimposition processing in the OSD superimposition portion 190 in accordance with the processing mode of the image processing portion 210 makes it possible for the information to be superimposed appropriately on the image by the OSD superimposition portion 190 and for the image with the superimposed information to be output correctly to the television 200.

Once the superimposition control portion 185, at Step S113, has set the superimposition processing in the OSD superimposition portion 190 in accordance with the processing mode of the image processing portion 210, the OSD superimposition portion 190 superimposes the information based on the superimposition processing that has been set by the superimposition control portion 185 (Step S114).

Once the OSD superimposition portion 190, at Step S114, has superimposed the information based on the superimposition processing that has been set by the superimposition control portion 185, the recorder 100 transmits the image on which the information has been superimposed to the television 200 (Step S115). Thus, controlling the method of superimposing the information in the recorder 100 in accordance with the processing mode of the television 200 makes it possible to output correctly to the television 200 the information that was superimposed in the recorder 100.

The operations of the recorder 100 and the television 200 according to the embodiment of the present invention in a case where the method for superimposing the information is controlled in the recorder 100 have been explained above using FIG. 8. Next, the operations of the recorder 100 and the television 200 according to the embodiment of the present invention (2) in a case where the display on the television 200 is controlled from the recorder 100 will be explained.

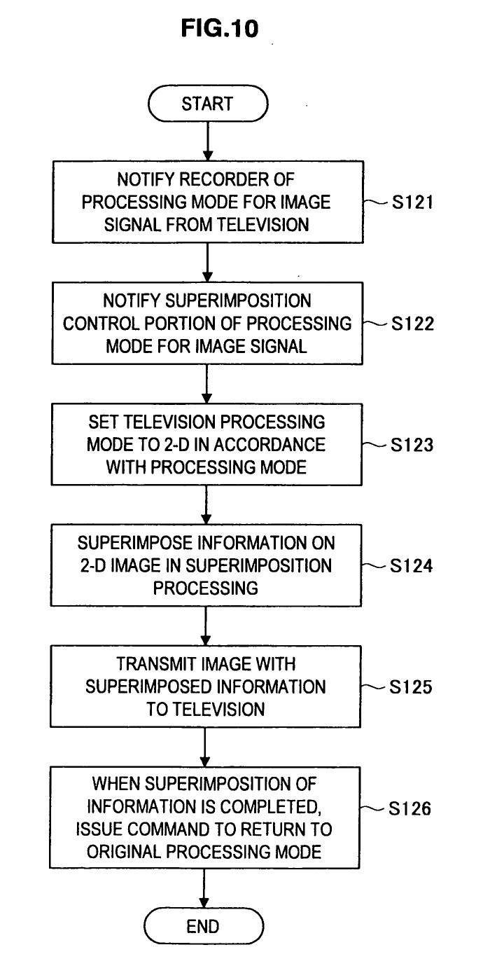

FIG. 10 is a flowchart that shows the operations of the recorder 100 and the television 200 according to the embodiment of the present invention (2) in a case where the display on the television 200 is controlled from the recorder 100. Hereinafter, the operations of the recorder 100 and the television 200 according to the embodiment of the present invention will be explained using FIG. 10.

First, in the television 200, the display state monitoring portion 230 monitors the image signal processing mode, as described previously. The image processing portion 210 performs the signal processing by operating in one of the five processing modes that were described earlier. Further, the display state monitoring portion 230 monitors the processing mode in which the image processing portion 210 is operating to perform the signal processing. The display state monitoring portion 230 transmits information on the processing mode of the image processing portion 210 to the recorder 100 (Step S121).

The information on the processing mode of the image processing portion 210 that is transmitted from the display state monitoring portion 230 may be acquired by the display state monitoring portion 180 through the High-Definition Multimedia Interface-Consumer Electronics Control (HDMI-CEC), for example. The display state monitoring portion 180, having acquired the information on the processing mode of the image processing portion 210, provides the information it has acquired on the processing mode of the image processing portion 210 to the superimposition control portion 185 (Step S122).

The superimposition control portion 185, having received the information on the processing mode of the image processing portion 210 from the display state monitoring portion 180 at Step S122, sets the processing mode of the television 200 to the 2-D mode, in accordance with the processing mode of the image processing portion 210 (Step S123). In order for the superimposition control portion 185 to set the processing mode of the television 200 to the 2-D mode, the superimposition control portion 185 may, for example, output a processing mode change request to the television 200 through the HDMI-CEC, and the recorder 100 may also output to the television 200 information on an HDMI InfoFrame that provisionally defines the image as two-dimensional.

Once the superimposition control portion 185 has set the processing mode of the television 200 to the 2-D mode at Step 5123, the superimposition control portion 185 issues a command to the OSD superimposition portion 190 such that the OSD superimposition portion 190 will perform the superimposition processing for a two-dimensional image. The OSD superimposition portion 190, having received the command from the superimposition control portion 185, superimposes the information on the image using the superimposition processing for a two-dimensional image (Step S124).

Once the OSD superimposition portion 190 has superimposed the information on the image using the superimposition processing for a two-dimensional image at Step S124, the recorder 100 transmits the image with the superimposed information to the television 200 (Step S125). Once the superimposing of the information has been completed in the recorder 100, the superimposition control portion 185 issues a command to the television 200 to return to the original processing mode that was being used before the processing mode of the television 200 was changed to the 2-D mode (Step S126). Note that in order for the superimposition control portion 185 to issue the command to the television 200 to return to the original processing mode that was being used before the processing mode of the television 200 was changed to the 2-D mode, it is desirable for information on the original processing mode to be stored in one of the recorder 100 and the television 200 when the processing mode of the television 200 is changed to the 2-D mode.

Having the command to change the processing mode of the television 200 issued from the recorder 100 when the recorder 100 superimposes the information on the image, and having the recorder 100 control the television 200 such that the processing mode of the television 200 returns to the original processing mode when the superimposing of the information has been completed make it possible for the information that is superimposed in the recorder 100 to be displayed correctly on the television 200.

### 2. Conclusion

According to the embodiment of the present invention that has been explained above, the television 200 transmits the processing mode of the image processing portion 210 to the recorder 100. The recorder 100, to which the processing mode of the image processing portion 210 has been transmitted from the television 200, performs control in order to output correctly to the television 200 the information that was superimposed in the recorder 100. Specifically, the superimposition control portion 185 controls one of the method by which the information is superimposed in the OSD superimposition portion 190 and the processing mode of the television 200. Having the superimposition control portion 185 perform in this manner the control for correctly outputting on the television 200 the information that was superimposed in the recorder 100 makes it possible for the information that was superimposed on the image in the recorder 100 to be output correctly on the television 200.

Note that in the embodiment of the present invention that has been explained above, a structure is provided, as shown in FIG. 4, that identifies the image format in the interior of the recorder 100, but the present invention is not limited to this example. That is, the structure that is shown in FIG. 4 that identifies the image format may also be provided in the television 200. In other words, a unit can be provided in the interior of the television 200 that, after the television 200 has decoded a stream that has been received from a broadcasting station, as well as after the television 200 has received a transmission of an image from an image output device that is connected to the television 200, other than the recorder 100, performs processing that identifies the image format, like the processing that is performed by the image format identification portion 160.

Furthermore, in the embodiment of the present invention that has been explained above, the recorder 100 is explained as an example of the image output device of the present invention, but the present invention is obviously not limited to this example. A stationary game unit, for example, as well as a personal computer or other information processing device may also be used as the image output device, as long as it has a function that outputs the image in the same manner as does the recorder 100.

The processing that has been explained above may be implemented in the form of hardware, and may also be implemented in the form of software. In a case where the processing is implemented by software, a storage medium in which a program is stored may be built into one of the recorder 100 and the television 200, for example. The program may then be sequentially read and executed by one of a central processing unit (CPU), a digital signal processor (DSP), and another control device that is built into one of the recorder 100 and the television 200.

The preferred embodiment of the present invention has been explained in detail above with reference to the attached drawings, but the present invention is not limited to this example. It should be understood by those possessing ordinary knowledge of the technical field of the present invention that various types of modified examples and revised examples are clearly conceivable within the scope of the technical concepts that are described in the appended claims, and that these modified examples and revised examples are obviously within the technical scope of the present invention.

For example, the embodiment has been explained using the image display system 10 that outputs a stereoscopic image as an example, but the present invention is not limited to this example. For example, the present invention may also be implemented in a display device that provides what is called a multi-view display, using a time-divided shutter system to display different images to a plurality of viewers. Unlike a stereoscopic image display, the multi-view display can display a plurality of images on a single display device by controlling shutters such that an image can be seen only through specific shutter glasses during a specified interval.

To take another example, in the embodiment, the superimposition control portion 185 performs control such that it forces the processing mode of the television 200 into the 2-D mode, regardless of the information that is superimposed, but the present invention is not limited to this example. For example, information for distinguishing between information that can be displayed in three-dimensional form without any problem and information that is preferably displayed in two-dimensional form may be stored in the interior of the recorder 100, such as in the superimposition control portion 185, for example, and the superimposition control portion 185 may control the processing mode of the television 200 in accordance with the nature of the information that will be superimposed by the OSD superimposition portion 190.

The present invention can be applied to an image processing device, an image control method, and a computer program, and can be applied in particular to an image processing device, an image control method, and a computer program that output an image that is displayed by displaying a plurality of images in a time-divided manner.

The present application contains subject matter related to that disclosed in Japanese Priority Patent Application JP 2010-004563 filed in the Japan Patent Office on Jan. 13, 2010, the entire content of which is hereby incorporated by reference.

What is claimed is:

1. An image processing device, comprising:
an information superimposition portion that superimposes specified information on an input image and outputs the image with the superimposed information;
a display format acquisition portion that acquires information about a display format of an image that is currently being displayed; and
a superimposition control portion that, based on the information that the display format acquisition portion has acquired about the display format of the image that is currently being displayed, performs control that relates to the superimposing of the superimposed information on the input image by the information superimposition portion.

2. The image processing device according to claim 1,
wherein the superimposition control portion issues a command to the information superimposition portion to superimpose the superimposed information in a manner that conforms to the display format of the image that is currently being displayed that has been acquired by the display format acquisition portion.

3. The image processing device according to claim 2,
wherein the superimposition control portion, in a case where the display format of the image that is currently being displayed that has been acquired by the display format acquisition portion is a side-by-side format, issues a command to the information superimposition portion to superimpose the same superimposed information on the left side and the right side of the image.

4. The image processing device according to claim 2,
wherein the superimposition control portion, in a case where the display format of the image that is currently being displayed that has been acquired by the display format acquisition portion is an over-under format, issues a command to the information superimposition portion to superimpose the same superimposed information on the upper side and the lower side of the image.

5. The image processing device according to claim 2,
wherein the superimposition control portion, in a case where the display format of the image that is currently being displayed that has been acquired by the display format acquisition portion is a frame sequential format, issues a command to the information superimposition portion to superimpose the superimposed information on the image in the same manner as the superimposed information is superimposed on a two-dimensional image.

6. The image processing device according to claim 1,
wherein the superimposition control portion transmits a command to display as a two-dimensional image the image that is currently being displayed.

7. The image processing device according to claim 6,
wherein the superimposition control portion controls the superimposing of the superimposed information on the input image by the information superimposition portion such that the superimposed information is displayed correctly when the image is displayed as a two-dimensional image.

8. The image processing device according to claim 6,
wherein the superimposition control portion, when the superimposing of the superimposed information by the information superimposition portion has been completed, transmits a command to display the image in the display format that was being used before the display was changed to the two-dimensional image.

9. An image control method, comprising the steps of:
superimposing specified information on an input image and outputting the image with the superimposed information;
acquiring information about a display format of an image that is currently being displayed; and
performing control, based on the information that has been acquired about the display format of the image that is currently being displayed, that relates to the superimposing of the superimposed information on the input image.

10. A computer program that causes a computer to perform the steps of:
superimposing specified information on an input image and outputting the image with the superimposed information;
acquiring information about a display format of an image that is currently being displayed; and
performing control, based on the information that has been acquired about the display format of the image that is currently being displayed, that relates to the superimposing of the superimposed information on the input image.
